(19) United States
(12) Patent Application Publication
(10) Pub. No.: US 2026/0084344 A1
(43) Pub. Date: Mar. 26, 2026

(54) METHOD FOR DEODORIZING RECOVERED VULCANIZED RUBBER CRUMB

(71) Applicant: COMPAGNIE GENERALE DES ETABLISSEMENTS MICHELIN, Clermont-Ferrand (FR)

(72) Inventors: JOSE MERINO LOPEZ, Clermont-Ferrand (FR); FREDERIC PIALOT, Clermont-Ferrand (FR); VINCENT ROBIN, Clermont-Ferrand (FR)

(21) Appl. No.: 19/109,858

(22) PCT Filed: Sep. 8, 2023
(86) PCT No.: PCT/FR2023/051357

§ 371 Date: Mar. 7, 2025

(30) Foreign Application Priority Data
Sep. 9, 2022 (FR) FR2209079

(51) Int. Cl. B29B 13/02; B29B 17/04; B29C 67/04; B29K 21/00

(52) U.S. Cl. CPC B29B 13/02; B29B 17/0412; B29C 67/04; B29K 2021/00

(57) ABSTRACT

A process for deodorizing a rubber granulate comprises a step of baking the rubber granulate, characterized in that the rubber granulate subjected to the baking treatment comprises rubber in the vulcanized state. Deodorized rubber granulates are capable of being obtained according to this process. A process for obtaining an article made of rubber granulate deodorized in this way and the articles made of deodorized rubber granulates that can be obtained according to the process are also disclosed. The deodorized rubber granulates are used for the production of playing fields, athletics tracks, playgrounds, shoe soles or solid castors, in particular castors for scooters, trolleys, gyropods or medical beds.

### FIELD OF THE INVENTION

The present invention relates to the field of articles made from deodorized rubber granulates.

The invention relates to a process for deodorizing vulcanized rubber granulates by baking.

### PRIOR ART

Currently, the question of recycling end-of-life tyres is increasingly being asked. The need which is felt more particularly is the capacity for reusing the material of the components or, in other words, for reprocessing with a view to recycling all or some of the material which constitutes a used tyre.

When it is desired to recycle used tyres, they are ground. The grinding is carried out in a machine fitted with powerful rotary shredding blades capable of grinding tyres of different sizes and types. The ground materials obtained or, in other words, the fragments of cut used tyres, have different sizes generally between 25 mm and 350 mm and an average composition identical to that of the original whole tyre.

In order to recycle the material from which they are made, the ground materials are treated in a granulator where they are ground more finely to obtain granulates therefrom. The granulates result from a very fine grinding of the rubber contained in the fragments of used tyres, generally after extraction of the textile fibres and metal threads contained in the tyres. The granulates thus obtained have a size of between 0.8 mm and 20 mm. The granulates can then be ground more finely and dried to obtain rubber crumb.

It is desired to be able to reuse these granulates or the rubber crumb obtained from these granulates directly in new rubber articles without having to subject them to a chemical functionalization or devulcanization modification, in particular without biological and/or chemical treatment.

Document FR 2 475 458 describes a sintering process for manufacturing articles made of recovered rubber which consists in depositing in a mould crumb mixed preferably with a vulcanizing agent, alone or as a mixture with an accelerator.

Document WO2020128212 describes a sintering process for manufacturing articles made of recovered rubber that makes it possible to dispense with the use of any bonding agent. The crumb particles used do not exceed 800 μm in size.

Document WO2020128213 describes a sintering process for manufacturing articles made of recovered rubber comprising the following steps. Crumb particles are mixed with particles of solute. A moulded article is then produced by sintering this mixture.

A step of bringing the moulded article into contact with a solvent makes it possible to dissolve at least a portion of the solute particles, making it possible to obtain partial or complete porosity of the moulded article.

Among the uses of the sintered articles obtained according to the processes described above, mention may be made of: treads for tyres, wheels or castors for scooters, inline skates, gyropods, etc., soles for shoes, floor coverings or underlayers for these, etc.

By using recycled materials, the processes for manufacturing such articles are economically and environmentally attractive.

However, in the context of their use, in particular in hot weather, such articles can generate odours.

When these articles are, for example, floor coverings for playing fields, these odours can be unpleasant for the users.

### SUMMARY OF THE INVENTION

There is therefore a need to develop articles, in particular sintered articles, based on rubber granulate comprising vulcanized rubber that emits fewer odours. Rubber granulates comprise volatile organic compounds trapped in the vulcanized rubber that will slowly evaporate and contribute to the odours emitted by the article over several weeks, months or years depending on the size of the article.

Surprisingly, it was found that baking the rubber granulates allowed the release of volatile substances, despite them being trapped in the vulcanized rubber, without devulcanizing the rubber granulates, i.e. without breaking the bridges, i.e. the covalent bonds, between the sulfur atoms.

A process for deodorizing a vulcanized rubber granulate has thus been developed, comprising baking of said granulate. In the process according to the invention, when subjected to the baking treatment, the rubber granulate comprises rubber in the vulcanized state. At the end of the baking treatment, the rubber granulate still comprises rubber in the vulcanized state.

The process of the invention makes it possible to deodorize the rubber granulate while retaining its vulcanized state. The rubber granulate deodorized in this way can be used as is for the manufacture of rubber articles, in particular by sintering.

### SUMMARY OF THE INVENTION

The invention relates to a process for deodorizing a rubber granulate comprising a step of baking said rubber granulate, characterized in that the rubber granulate subjected to the baking treatment comprises rubber in the vulcanized state, the rubber granulate being heated during the baking step at a temperature of between 55° C. and 180° C., preferentially between 60° C. and 130° C., even more preferentially between 65° C. and 120° C., particularly preferably between 75° C. and 110° C., for a period of time between a minimum value and a maximum value as indicated in the table below:

TABLE 1

| | | |
|---|---|---|
| Temperature | Minimum time | Maximum time |

| | | | | | |
|---|---|---|---|---|---|
| 55° | C. | 1.2 | weeks | 3 | weeks |
| 60° | C. | 0.8 | weeks | 2 | weeks |
| 65° | C. | 0.6 | weeks | 1.6 | weeks |
| 70° | C. | 2.8 | days | 7.1 | days |
| 75° | C. | 2.1 | days | 5.3 | days |
| 80° | C. | 1.4 | days | 3.6 | days |
| 85° | C. | 1.1 | days | 2.7 | days |
| 90° | C. | 0.7 | days | 1.8 | days |
| 95° | C. | 12.5 | hours | 1.3 | days |
| 100° | C. | 8.5 | hours | 21.3 | hours |
| 105° | C. | 6.4 | hours | 16.0 | hours |
| 110° | C. | 4.3 | hours | 10.7 | hours |
| 115° | C. | 3.2 | hours | 8 | hours |
| 120° | C. | 2.1 | hours | 5.3 | hours |
| 125° | C. | 1.6 | hours | 4 | hours |
| 130° | C. | 1.1 | hours | 2.7 | hours |
| 135° | C. | 48 | minutes | 120 | minutes |
| 140° | C. | 32 | minutes | 80 | minutes |
| 145° | C. | 24 | minutes | 60 | minutes |
| 150° | C. | 15 | minutes | 40 | minutes |
| 155° | C. | 12 | minutes | 30 | minutes |
| 160° | C. | 8 | minutes | 20 | minutes |
| 165° | C. | 6 | minutes | 15 | minutes |
| 170° | C. | 4 | minutes | 10 | minutes |
| 175° | C. | 3 | minutes | 7.5 | minutes |
| 180° | C. | 2 | minutes | 5 | minutes |

and said baking step not comprising any devulcanization means.

Preferentially, the pressure used during the baking step is between 2*10⁴ Pa and atmospheric pressure, preferentially between 3*10⁴ Pa and 5*10⁴ Pa.

Preferentially, the rubber granulate is in the form of particles, the volume mean diameter D50 of which is between 0.8 mm and 20 mm, preferentially between 0.8 mm and 8 mm.

Preferentially, the rubber granulate is a rubber crumb in the form of particles, the volume mean diameter D50 of which is between 10 μm and 800 μm, preferentially between 50 μm and 200 μm.

Preferentially, the emission of total volatile organic compounds by the rubber granulate, after the baking step, is reduced compared to that of the rubber granulate before the baking step.

Preferentially, the reduction in the emission of total volatile organic compounds by the rubber granulate, after the baking step, is greater than 50% by weight, preferentially greater than 70% by weight.

Preferentially, the process for deodorizing the rubber granulate comprises a prior step of grinding a vulcanized rubber article, preferably used tyres or fragments of used tyres, to provide said rubber granulate.

Another subject of the invention is a deodorized rubber granulate capable of being obtained according to the process as described above.

Another subject of the invention is a process for manufacturing an article made of rubber granulate comprising the following successive steps:
a. providing a deodorized rubber granulate capable of being obtained according to the deodorization process as described above;
b. optionally, preparing a composition comprising said granulate and, for example, metallic, inorganic or organic particles, it being possible for said inorganic or organic particles to be a salt, a saccharide, a water-soluble protein or a water-soluble polymer;
c. sintering the deodorized granulate or the composition comprising it in a mould;
d. recovering the article obtained at the end of step c.

According to one embodiment, the deodorized rubber granulate from step a. is prepared by performing the following successive steps:
a1. providing a granulate comprising rubber in the vulcanized state;
a2. deodorizing said granulate according to the deodorization process as described above.

Preferentially, step c. directly follows the baking step applied to the granulate comprising vulcanized rubber during step a2. so that said granulate is introduced into the mould for the forming thereof by sintering at a temperature above 30° C., preferentially above 40° C.

Preferentially, the process for manufacturing an article made of rubber granulate comprises a step, prior to step a1., of grinding a vulcanized rubber article, preferably used tyres or fragments of used tyres, to provide the granulate comprising rubber in the vulcanized state.

Another subject of the invention is an article made of deodorized rubber granulate capable of being obtained by the process as described above.

Another subject of the invention is a the use of the article made of rubber granulate as described above for the production of playing fields, athletics tracks, playgrounds, shoe soles or solid wheels, in particular wheels for scooters, trolleys, gyropods or medical beds.

Other aspects of the invention are as described below and in the claims.

### Definitions

The term “vulcanized rubber” is understood to mean a rubber crosslinked with a sulfur-based crosslinking system.

The term “room temperature” is understood to mean a temperature ranging from 18° C. to 22° C.

The terms “granulate” and “granulates” are interchangeable. “Granulate” or “granulates” means ground tyre material treated in a granulator where they are ground more finely. The granulates thus obtained generally have a volume mean diameter D50 of less than 20 mm. Advantageously, the granulates obtained have a volume mean diameter D50 of between 0.8 mm and 20 mm. These granulates can then be ground more finely and dried to obtain rubber crumb, the volume mean diameter D50 of which is less than 800 μm. For the purposes of the present invention, the term “granulate” or “granulates” is therefore also understood to mean, where appropriate, the rubber crumb thus obtained.

The term “particles” is understood to mean particles which have a size, namely their volume mean diameter D50, of a few tens of microns to a few millimetres.

The mean diameter D50 of the granulate particles is a volume mean diameter D50 and can be measured by laser diffraction particle size analysis or by sieve analysis for particles with a D50 of greater than 1 mm. Particles with a diameter smaller than the D50 represent 50 vol % of the volume of all of the particles.

The “sintering” of rubber granulates is understood to mean a step of shaping a predetermined amount of granulate by heating at a temperature below the vulcanization temperature of the grains that make it up and at the same time pressurizing this amount of granulate in the cavity of a mould.

### DESCRIPTION OF THE FIGURES

FIG. 1 represents the concentration of total volatile organic compounds, expressed in ppm (parts per million), emitted by the various granulates of recovered vulcanized rubber of the examples before and after implementation of the deodorization process according to the invention.

FIG. 2 represents the results of the sensory evaluation of the subjective concentration of odours emitted by the various granulates of recovered vulcanized rubber of the examples before and after implementation of the deodorization process according to the invention. Plotted on the y-axis is the number of points obtained following scoring by the trained panel. The figures are therefore unitless.

### DETAILED DESCRIPTION OF THE INVENTION

### Process for Deodorizing a Rubber Granulate

The inventors have developed a process for deodorizing a rubber granulate while retaining the vulcanized state thereof.

The rubber granulates are obtained from a grinding or from a micronization of cured rubber compositions which are new or which have already been used for a first application, for example in tyres. They are advantageously a material recycling product. They are thus advantageously obtained from the grinding of tyres that are already vulcanized, whether they are used or new. Such a tyre is selected from tyres intended to equip a two-wheel vehicle, a passenger vehicle, or else a “heavy-duty” vehicle (that is to say, underground trains, buses, off-road vehicles, heavy road transport vehicles, such as lorries, tractors or trailers), or else aircraft, construction equipment, heavy agricultural vehicles or handling vehicles. The granulate used is that obtained by grinding a portion previously detached from the tyre, for example from a tread, sidewalls, etc. or it is obtained by grinding the entire tyre. In the latter case, the granulate is also advantageously subjected to a step during which the textile or metal residues present in the tyre are removed.

The rubber granulate is in the form of particles.

Advantageously, the rubber granulate is in the form of particles, the volume mean diameter D50 of which is between 0.8 mm and 20 mm, preferentially between 0.8 mm and 8 mm.

Advantageously, the rubber granulate is a rubber crumb in the form of particles, the volume mean diameter D50 of which is between 10 μm and 800 μm, preferentially between 50 μm and 200 μm.

Thus, the rubber granulate, whether or not it is in crumb form, is in the form of individual particles and not a paste comprising rubber, even partially vulcanized rubber.

The granulates are advantageously simple ground rubber material, without further treatment, i.e. the granulates have not undergone any other treatment than grinding operations aimed at reducing their size and, where appropriate, extracting the residues of textile and mechanical reinforcements present. In particular, the granulates were not subjected to chemical functionalization or devulcanization modification. In particular, the granulates were not subjected to modifications by biological and/or chemical treatment.

A so-called primary grinding makes it possible to obtain, from tyres, fragments of cut tyres having different sizes (D50) generally between 25 mm and 350 mm and an average composition identical to that of the original whole tyre.

A granulation step makes it possible to reduce the size of the ground material obtained on conclusion of the primary grinding.

The granulation comprises a first dissociation step consisting in reducing the size of the ground material to obtain a particle size that is sufficient to allow the separation of the rubbers and textile and metal reinforcements. Once dissociated, the materials are sorted during a second step. When the granulates have a size smaller than 2.5 mm, the sorting step is facilitated and it is generally possible to obtain granulates free of metal and textile residues.

The granulates obtained generally have a size of between 0.8 mm and 20 mm.

The granulates can also be ground more finely and dried to obtain rubber crumb, the particles of which have a size smaller than 800 μm.

By enabling the metal and textile residues to be removed, this process makes it possible to obtain crumbs containing only the rubber composition.

The grinding to obtain the granulates and, where appropriate, a crumb of given size, can be carried out by various technologies.

The use of knife mills composed of a rotor, a stator and a screen makes it possible, by successive grinding, to reduce the size of the particles.

Grinding by crushing can be carried out using a Kahl granulator. This type of granulator comprises fins for declumping the material to be ground, rollers for crushing the material and forcing it to pass through a die.

Cryogenic impact micronization technologies make it possible to obtain particles of small size from rubber materials. Commercial items of equipment, such as the CUM150 mill from Netzsch or the CW250 mill from Alpine, can be used. Screening steps follow the grinding in order to select particles having a predetermined average size.

Advantageously, the granulate has an acetone extract of between 3% and 15% by weight, more preferentially within a range of from 3% to 10% by weight. Likewise, it is preferable for the granulate to have a chloroform extract of between 3% and 20% by weight, more preferentially within a range of from 5% to 15% by weight. Preferentially, the chloroform extract of the rubber granulate has a weight-average molecular weight (Mw) of less than 10 000 g/mol, preferably of less than 8000 g/mol.

It is preferable for the ratio of the chloroform extract to the acetone extract, expressed as weight percentage, to be less than 1.5.

The granulate is advantageously stripped of the textile or metal residues present in the tyre. However, it is possible to envisage using a rubber granulate which has metallic or textile inclusions.

The granulates preferably consist of a composition based on an elastomer and a filler.

They may also comprise all the ingredients normally used in rubber compositions, such as plasticizers, antioxidants, vulcanization additives, etc.

Thus, the granulate comprises an elastomer, preferentially a diene elastomer. This elastomer preferentially represents at least 30% by weight, more preferentially at least 35% by weight, even more preferentially at least 45% by weigh relative to the weight of the granulate, said percentage being determined according to standard ASTM E1131.

It is preferentially selected from the group consisting of polybutadienes, polyisoprenes including natural rubber, butadiene copolymers and isoprene copolymers. More preferentially, the molar content of sub-units of diene origin (conjugated dienes) present in the diene elastomer is greater than 50%, preferably between 50% and 70%.

According to a preferential embodiment of the invention, the granulate contains between 5% and 80% by weight of filler, more preferentially between 10% and 75% and very preferentially between 15% and 70%.

The term “filler” is understood here to mean any type of filler, whether it is reinforcing (typically having nanometric particles, preferentially with a weight-average size of less than 500 nm, in particular between 20 nm and 200 nm) or whether it is non-reinforcing or inert (typically having micrometric particles, preferentially with a weight-average size of greater than 1 μm, for example between 2 μm and 200 μm). The weight-average size of the nanometric particles is measured in a manner well known to those skilled in the art (by way of example, according to application WO2009/083160 paragraph 1.1). The weight-average size of the micrometric particles can be determined by mechanical sieving.

Mention will in particular be made, as examples of fillers known as reinforcing to those skilled in the art, of carbon black or of a reinforcing inorganic filler, such as silica or alumina in the presence of a coupling agent, or mixtures thereof.

The granulates comprise vulcanized rubber, i.e. rubber crosslinked with a sulfur-based crosslinking system.

The granulate may also contain the reaction products or residues of at least one vulcanization accelerator and, optionally, various known vulcanization activators such as zinc oxide, stearic acid or equivalent compound such as stearic acid salts and transition metal salts, guanidine derivatives (in particular diphenylguanidine), or else known vulcanization retarders.

As examples of accelerators, mention may notably be made of accelerators of the thiazole type, and also derivatives thereof, or accelerators of sulfenamide, thiuram, dithiocarbamate, dithiophosphate, thiourea and xanthate types. As examples of such accelerators, mention may notably be made of the following compounds: 2-mercaptobenzothiazyl disulfide (abbreviated as MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

The granulate may contain all the other usual additives, or reaction products or residues thereof, which are incorporated in a rubber composition, in particular for a tyre. Mention may be made, among these usual additives, of liquid or solid plasticizers, non-reinforcing fillers, such as chalk or kaolin, or protective agents. These additives may also be in the granulate in the form of a residue or of a derivative, since they were able to react during the steps of manufacturing the composition or of crosslinking the composition from which the granulate is derived.

The granulate will also comprise at least one volatile organic compound advantageously having a molar mass of less than 130 g/mol.

The objective of the process is to reduce the emission of total volatile organic compounds from the rubber granulate.

The baking step according to the deodorization process of the invention is applied to a rubber granulate comprising vulcanized rubber as has just been described.

Advantageously, the rubber granulate subjected to the baking treatment has not undergone any, even partial, devulcanization step.

A first subject of the invention thus relates to a process for deodorizing a rubber granulate comprising a step of baking said granulate, characterized in that the rubber granulate subjected to the baking treatment comprises rubber in the vulcanized state. the rubber granulate being heated during the baking step at a temperature of between 55° C. and 180° C., preferentially between 60° C. and 130° C., even more preferentially between 65° C. and 120° C., particularly preferably between 75° C. and 110° C., for a period of time between a minimum value and a maximum value as indicated in the table below:

TABLE 1

| | | |
|---|---|---|
| Temperature | Minimum time | Maximum time |

| | | | | | |
|---|---|---|---|---|---|
| 55° | C. | 1.2 | weeks | 3 | weeks |
| 60° | C. | 0.8 | weeks | 2 | weeks |
| 65° | C. | 0.6 | weeks | 1.6 | weeks |
| 70° | C. | 2.8 | days | 7.1 | days |
| 75° | C. | 2.1 | days | 5.3 | days |
| 80° | C. | 1.4 | days | 3.6 | days |
| 85° | C. | 1.1 | days | 2.7 | days |
| 90° | C. | 0.7 | days | 1.8 | days |
| 95° | C. | 12.5 | hours | 1.3 | days |
| 100° | C. | 8.5 | hours | 21.3 | hours |
| 105° | C. | 6.4 | hours | 16.0 | hours |
| 110° | C. | 4.3 | hours | 10.7 | hours |
| 115° | C. | 3.2 | hours | 8 | hours |
| 120° | C. | 2.1 | hours | 5.3 | hours |
| 125° | C. | 1.6 | hours | 4 | hours |
| 130° | C. | 1.1 | hours | 2.7 | hours |
| 135° | C. | 48 | minutes | 120 | minutes |
| 140° | C. | 32 | minutes | 80 | minutes |
| 145° | C. | 24 | minutes | 60 | minutes |
| 150° | C. | 15 | minutes | 40 | minutes |
| 155° | C. | 12 | minutes | 30 | minutes |
| 160° | C. | 8 | minutes | 20 | minutes |
| 165° | C. | 6 | minutes | 15 | minutes |
| 170° | C. | 4 | minutes | 10 | minutes |
| 175° | C. | 3 | minutes | 7.5 | minutes |
| 180° | C. | 2 | minutes | 5 | minutes |

and said baking step not comprising any devulcanization means.

The baking step is carried out in any closed heat treatment device, in particular an oven, which allows the granulate to be heated homogeneously and evenly, where appropriate under a partial vacuum. Ovens with natural or forced convection, advantageously with forced convection, are preferred.

Heating by infrared radiation does not make it possible to heat the granulate sufficiently homogeneously.

Heating by microwave radiation is also not preferred because it is more difficult to control.

In order to make the deodorization more effective, the granulate can be moved in the heat treatment device. For example, the heat treatment device may include a rotating tube with blades for making the granulate particles rise and fall and so on and so forth inside the tube.

Advantageously, the baking step is carried out without applying mechanical stress of the kneading or shearing type to the rubber granulates resulting in a modification of the size thereof.

The temperature within the heat treatment device is maintained at a temperature above room temperature and below 180° C., in order to avoid degradation of the rubber.

According to one embodiment, the temperature in the heat treatment device is between 55° C. and 180° C., preferentially between 60° C. and 130° C., even more preferentially between 65° C. and 120° C., particularly preferably between 75° C. and 110° C.

The temperature is the temperature measured inside the heat treatment device by any suitable means, for example a temperature probe.

For example, in the case of a rotating device, the temperature measuring device may be in contact with the moving bed of granulate particles inside the device.

Baking can be carried out under vacuum, in particular under 10% to 80% partial vacuum, advantageously under 50% to 70% partial vacuum. Thus, in the device, the pressure of the air inside the heat treatment device advantageously varies from 20 000 Pa to 90 000 Pa, more advantageously from 30 000 Pa to 50 000 Pa.

Baking can also be carried out under atmospheric pressure or under a light vacuum, i.e. from 0% to 10% vacuum. Thus, in the device, the pressure of the air inside the heat treatment device advantageously varies from 90 000 Pa to 101 325 Pa.

Advantageously, the pressure used during the baking step is thus between 2*10⁴ Pa and atmospheric pressure, preferentially between 3*10⁴ Pa and 5*10⁴ Pa.

The duration of the heat treatment step depends on multiple factors such as the type of device used, the amount of granulate to be deodorized, the size of the granulate to be deodorized and the temperature of the granulate during the treatment.

Thus, the duration of the heat treatment step can range from a few minutes, for example 5 minutes, to several weeks, for example 3 weeks.

The duration of the deodorization step depends very particularly on the temperature at which the deodorization step is carried out.

The duration of the deodorization step is thus chosen so as to avoid the reversion of the vulcanized rubber of the granulate, i.e. so as to avoid degradation of the rubber.

The maximum duration of the deodorization step, that is to say, which does not cause reversion of the rubber, can easily be determined by means of nomograms available to a person skilled in the art.

The duration of the deodorization step must also be sufficient to allow the deodorization of the rubber granulate.

The baking step does not comprise any devulcanization means. Thus, the process according to the invention makes it possible to deodorize the rubber granulate while retaining its vulcanized state.

A “devulcanization means” is understood to mean any means for breaking bonds in the three-dimensional structure of the vulcanized rubber, in particular the S—S bonds.

Devulcanization means are well known to a person skilled in the art. Mention may be made of thermomechanical processes, mechanochemical processes or else grinding.

The use of thermal processes with sufficiently high temperatures can also lead to a reversion of the rubber granulate.

The baking step is carried out in the absence of a devulcanizing agent. As devulcanizing agent or fragmentation agent, mention may be made, for example, of the agents disclosed in application EP3541867A1 such as hexadecylamine (HDA) or alternatively diphenyldisulfide (DPDS).

Advantageously, the baking step is carried out on the rubber granulates alone, in the absence of any other component.

The baking step is carried out without applying mechanical stress of the kneading or shearing type resulting in a devulcanization of the rubber of the granulates.

The deodorization process can be a batch process consisting in loading the heat treatment device with the granulate to be deodorized, applying the heat treatment as described above and then recovering the thus deodorized granulate.

The deodorization process can be a process consisting in continuously feeding the heat treatment device with the granulate to be deodorized. The thus deodorized granulate is then continuously recovered at the outlet of the heat treatment device.

The deodorization process according to the invention makes it possible to remove a portion of the volatile components (VOCs) present in the granulate.

According to one embodiment, the emission of total volatile organic compounds by the rubber granulate, after the baking step, is reduced compared to that of the rubber granulate before the baking step.

Advantageously, the reduction in the emission of total volatile organic compounds after the baking step is greater than 50% by weight, preferentially greater than 70% by weight.

The content of total volatile organic compounds emitted may be measured using an automatic analyser with a photoionization detector (PID) or with a flame ionization detector (FID). Preferentially, an analyser with a photoionization detector (PID) is used.

Advantageously, said volatile organic compounds, the content of which is reduced by the heat treatment step, comprise at least one volatile organic compound having a molar mass of less than or equal to 130 g/mol.

Various analytical methods allow these volatile organic compounds to be specifically detected and quantified. Mention is made of gas chromatography with flame ionization detectors (FID), photoionization detectors (PID), or mass spectrometry (MS) detectors, high performance liquid chromatography (HPLC) with UV detectors, μGC/TCD/MS coupling or Fourier transform infrared spectroscopy (FTIR).

The rubber granulate used is advantageously recovered rubber granulate. The process according to the invention may therefore comprise a prior step of grinding a vulcanized rubber article, preferably used tyres or fragments of used tyres, to provide the vulcanized rubber granulate used in the process.

The deodorization process enables the rubber granulate to be deodorized while retaining its vulcanized state. The rubber granulate thus deodorized can be reused as is for the manufacture of articles, notably by sintering.

### Deodorized Rubber Granulate

Another subject of the invention relates to a deodorized rubber granulate obtained according to the deodorization process as described above.

The deodorized rubber granulate has the same characteristics as the rubber granulate before baking in terms of its size and composition, except for its content of volatile organic compounds which has been reduced.

Advantageously, the emission of total volatile organic compounds by the deodorized rubber granulate is reduced by at least 50%, preferentially by at least 70%, compared to that of the non-deodorized granulate.

Advantageously, said volatile organic compounds, the emission of which is reduced by the baking step, comprise at least one volatile organic compound having a molar mass of less than or equal to 130 g/mol.

The vulcanized rubber granulate before implementation of the deodorization process is as described above.

The deodorized rubber granulate is capable of being obtained according to the deodorization process as described above.

### Process for Manufacturing an Article Made of Rubber Granulate

The deodorized granulate as described above can then be used for the manufacture of rubber articles. The fact that it is still vulcanized allows its to be used directly, without the need to add vulcanizing agents in particular thereto.

In particular, it can be used in a sintering process, in particular for crumb, in the processes described in patent applications WO2020/128212 and WO2020/128213.

Thus, another subject of the invention relates to a process for manufacturing an article made of rubber granulate, comprising the following steps:
a. providing a deodorized rubber granulate capable of being obtained according to the deodorization process as described above;
b. optionally, preparing a composition comprising said granulate and, for example, metallic, inorganic or organic particles, it being possible for said inorganic or organic particles to be a salt, a saccharide, a water-soluble protein or a water-soluble polymer;
c. sintering the deodorized granulate or the composition comprising it in a mould;
d. recovering the article obtained at the end of step c.

According to one embodiment, the deodorized rubber granulate from step a. is prepared by performing the following successive steps:
a1. providing a granulate comprising rubber in the vulcanized state as described above;
a2. deodorizing said granulate according to the deodorization process as described above.

Step c. makes it possible to shape the article by agglomerating together particles of rubber granulate.

The deodorized granulate is the deodorized rubber granulate capable of being obtained by the deodorization process as described above or else it is the granulate obtained on conclusion of the deodorization step a2. The composition comprising it is the composition comprising the granulate obtained on conclusion of step b. of preparing said composition.

The sintering is advantageously a solid-state sintering of the granulate grains, in other words an agglutination of the deodorized rubber granulate grains which remain in the solid state throughout the sintering. Heating and pressurization of the granulate create a sintered agglomerate of granulate particles. Thus, the compression creates a physical coming together of the particles and the heating promotes molecular mobility and therefore this coming together. Under the effect of temperature, molecular mobility increases and gives rise to an intermolecular interaction of the type of van der Waals forces, which creates a strong physical bond or physisorption between the molecules of the various granulate particles.

Advantageously, step c. includes the following substeps:
c1. introducing the granulate into the mould; then
c2. compressing the granulate to a preset nominal pressure while maintaining the heating of the mould at a selected nominal temperature for a predetermined time; then
c3. cooling the mould to a temperature below the working temperature for a predetermined cooling time;
c4. opening the mould.

Advantageously, the granulate introduced into the mould during step c1. is subjected, during step c2., to a nominal temperature of between 100° C. and 150° C. and to a nominal pressure of between 20×10⁵ Pa and 200×10⁵ Pa for a time of between 2 and 15 minutes.

Advantageously, the granulate introduced into the mould during step c1. is subjected, during step c2., to a nominal temperature of 120° C., to a nominal pressure of 100×10⁵ Pa for a period of 10 minutes.

Advantageously, the step of cooling the article in the mould takes place at a temperature below 50° C. and preferably at room temperature.

The sintering is carried out on granulate particles in a vulcanized state. Advantageously, the article obtained on conclusion of step d. therefore does not need to undergo an additional post-curing step.

According to one embodiment, step c. follows directly, i.e. without an intermediate step, the heat treatment step applied to the granulate comprising vulcanized rubber during step a2. In this variant, the granulate is introduced into the mould for the shaping thereof by sintering at a temperature above 30° C., preferentially above 40° C., more preferentially above 60° C.

This embodiment makes it possible to save energy because the granulate is still hot from the baking heat treatment step when it is introduced into the sintering mould. It also makes it possible to reduce the sintering cycle time by reducing the temperature rise time of the granulate up to the sintering temperature. It also makes it possible to obtain a better homogeneity of the temperature of the granulate during sintering, in particular with a reduction, or even an absence, of a temperature gradient between the granulate in contact with the wall of the mould and the core of the mass of granulate within the sintering mould.

Step b. is an optional step for obtaining a composition comprising the deodorized granulate obtained on conclusion of step a.

It is thus possible to include, during step b., solid particles of predetermined size, in particular metallic, mineral or organic particles, in order to modify the mechanical properties, for example the stiffness of the sintered article obtained. By way of example, it is possible to add particles of a thermoplastic material of controlled stiffness and of predetermined size in order to modify the final stiffness of the sintered article.

It is also possible to mix granulate particles with solute particles as described in document WO2020128213, it been possible for the solute particles to be a salt, a saccharide, a water-soluble protein or a water-soluble polymer. The moulded article obtained by sintering this mixture and recovered on conclusion of step e. is then subjected to a step of coming into contact with the solvent that makes it possible to dissolve at least a portion of the solute particles and to thus obtain partial or complete porosity of the article recovered.

Advantageously, the rubber granulate used is a recovered rubber granulate. The process therefore advantageously comprises a step, prior to step a1., of grinding a vulcanized rubber article, preferably used tyres or fragments of used tyres, to provide the rubber granulate.

Advantageously, the granulate from step a1. is a crumb, the particles of which have an average size not exceeding 800 μm. In particular, the rubber crumb has an average particle size of between 200 and 800 μm, and preferentially of around 400 μm.

In this variant, advantageously, during this process, no vulcanization additive, binder or bonding additive is added. Thus, when it is prepared, the composition from step b. used in step c. is advantageously devoid of vulcanization additive, binder or bonding additive other than those intrinsically provided by the rubber crumb.

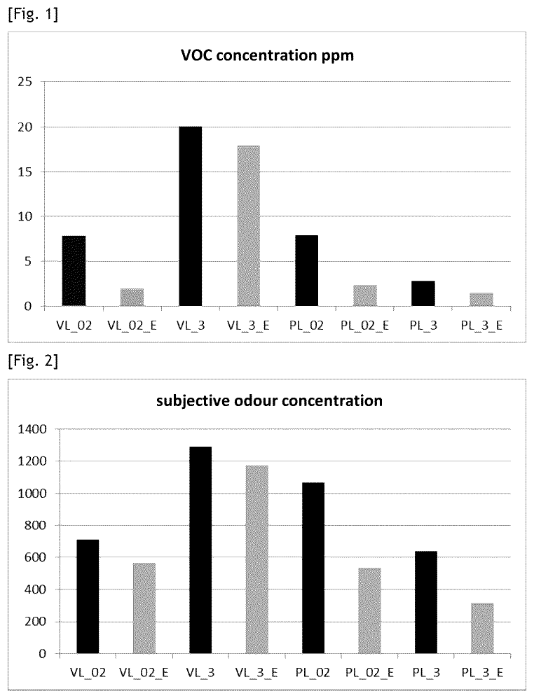

Step c. of shaping by sintering is advantageously as described in patent applications WO2020/128212 and WO2020/128213, in particular as detailed in FIG. 1 of each of these applications.

By using crumb particles with a size of less than 800 μm, the articles obtained by sintering the crumb alone and recovered on conclusion of step d. exhibit excellent mechanical properties.

According to one embodiment, an article is produced by sintering only the crumb particles having a mean size of less than or equal to 800 μm without the addition of vulcanization additive or binder.

### Article Made of Deodorized Rubber Granulate

Another subject of the invention relates to an article made of deodorized rubber granulate capable of being obtained by the manufacturing process as described above. Advantageously, the emission of total volatile organic compounds by the article made of deodorized rubber granulate is reduced by at least 50%, preferentially by at least 70%, compared to that of the article made of non-deodorized rubber granulate.

Advantageously, said volatile organic compounds, the emission of which is reduced by the baking step, have a molar mass of less than or equal to 130 g/mol.

### Use

Another subject of the invention relates to the use of the deodorized rubber granulate as described above or of the article comprising it as described above for the manufacture, for example, of playing fields, athletics tracks, playgrounds, shoe soles or solid castors, in particular castors for scooters, gyropods, trolleys or medical beds.

The examples which follow are given by way of illustration but should not under any circumstances be regarded as limiting of the present invention.

### EXAMPLES

In the example below, a deodorization process according to the invention is applied to various rubber granulates. The emission of odours by the granulates deodorized according to the process is evaluated.

### Granulates Used:

crumb (VL_02) from light vehicle (VL) used tyres having a particle size (D50) of less than 0.2 mm;
granulate (VL_3) from light vehicle (VL) used tyres having a particle size (D50) of less than 3 mm;
crumb (PL_02) from heavy-duty vehicle (PL) used tyres having a particle size (D50) of less than 0.2 mm;
granulate (PL_3) from heavy-duty vehicle (PL) used tyres having a particle size (D50) of less than 3 mm.

The size of the granulate particles, volume mean D50, is measured by laser diffraction particle size analysis using a Malvern Mastersizer apparatus for the crumbs (VL_02 and PL_02) and by sieve analysis for the granulates (VL_3 and PL_3).

### Oven Heat Treatment Step:

Each type of granulate is placed in a static oven for 11 days, at a temperature of 65° C. and under a pressure of 900 mbar.

### Characterization of the Granulates Before/after the Heat Treatment Step:

The granulates before the oven heat treatment step are respectively referenced VL_02, VL_3, PL_02 and PL_3, as indicated above.

After heat treatment, the corresponding granulates are respectively referenced VL_02_E, VL_3_E, PL_02_E and PL_3_E.

The granulates are subjected to a protocol for measuring the content of volatile organic compounds (VOCs) and to a test for sensory evaluation of their odour.

The study is carried out at room temperature, in a temperature-controlled room. For each type of granulate, the experimental conditions are as follows:
1. Packaging of the granulates in Nalophan® bags: An amount of granulates corresponding to a volume of 300 ml of each material is introduced into a Nalophan® bag subsequently filled with 40 L of nitrogen. The samples are then placed in a temperature-controlled room (T=20±2° C.).
2. Verification that emission from the granulates has reached equilibrium by periodic measurements of the VOCs emitted. The concentration of VOCs emitted by the materials is monitored regularly until thermodynamic equilibrium is reached using a portable photoionization analyser (RAE Systems/ppb RAE). Since this apparatus is calibrated with isobutene, the measured concentrations are expressed as equivalent ppm of isobutene. The values given below correspond to the values measured at equilibrium.
3. Sensory analyses (odour concentration, acceptability and quality). For these sensory analyses conducted by a panel of 6 trained individuals, the odourous gas to be analysed is presented at various concentrations in the form of successive dilutions. This sensory analysis was carried out with an Odile® multistation dynamic dilution olfactometer and complies with the NF 13725 standard. For each dilution, each person indicates whether or not they perceived the odour. Thus, for each person and then for the whole panel, the threshold of perception (odour concentration) of odours could be determined.

### Results of Tests for Measuring the VOC Content of the Granulates:

The concentration of VOCs emitted by the granulates is shown in FIG. 1.

In all cases, baking made it possible to reduce the amount of VOCs in the granulate.

Baking is more effective (greater degree of VOC reduction after heat treatment) when it is applied to a granulate of fine particle size (crumbs VL_02_E and PL_02_E) rather than to a granulate consisting of particles of larger size (granulates VL_3_E and PL-3_E).

The VOC emissions from the materials of fine particle size (crumbs VL_02_E and PL_02_E) are independent of their origin (light vehicle or heavy-duty vehicle). Passing through the oven makes it possible to reduce their VOC content from 7.8 ppm to 2.2 ppm on average, which corresponds to a decrease in the VOC content of 70%.

### Results of the Sensory Analysis Tests:

The results of the sensory evaluation are shown in FIG. 2.

The values shown on the y-axis are relative values and it is the decrease in this value after baking (expressed as a percentage) which should be taken into account in order to evaluate the effectiveness of the deodorization process.

In all cases, the granulates after baking have a lower subjective odour level than the untreated granulates.

1.-12. (canceled)

13. A method for deodorizing a rubber granulate comprising:
a step of baking the rubber granulate,
wherein the rubber granulate subjected to the baking treatment comprises rubber in a vulcanized state,
wherein the rubber granulate is heated during the baking step at a temperature of between 55° C. and 180° C., for a period of time between a minimum value and a maximum value as set forth below:

| | | |
|---|---|---|
| Temperature | Minimum time | Maximum time |
| | | | | | |
|---|---|---|---|---|---|
| 55° | C. | 1.2 | weeks | 3 | weeks |
| 60° | C. | 0.8 | weeks | 2 | weeks |
| 65° | C. | 0.6 | weeks | 1.6 | weeks |
| 70° | C. | 2.8 | days | 7.1 | days |
| 75° | C. | 2.1 | days | 5.3 | days |
| 80° | C. | 1.4 | days | 3.6 | days |
| 85° | C. | 1.1 | days | 2.7 | days |
| 90° | C. | 0.7 | days | 1.8 | days |
| 95° | C. | 12.5 | hours | 1.3 | days |
| 100° | C. | 8.5 | hours | 21.3 | hours |
| 105° | C. | 6.4 | hours | 16.0 | hours |
| 110° | C. | 4.3 | hours | 10.7 | hours |
| 115° | C. | 3.2 | hours | 8 | hours |
| 120° | C. | 2.1 | hours | 5.3 | hours |
| 125° | C. | 1.6 | hours | 4 | hours |
| 130° | C. | 1.1 | hours | 2.7 | hours |
| 135° | C. | 48 | minutes | 120 | minutes |
| 140° | C. | 32 | minutes | 80 | minutes |
| 145° | C. | 24 | minutes | 60 | minutes |
| 150° | C. | 15 | minutes | 40 | minutes |
| 155° | C. | 12 | minutes | 30 | minutes |
| 160° | C. | 8 | minutes | 20 | minutes |
| 165° | C. | 6 | minutes | 15 | minutes |
| 170° | C. | 4 | minutes | 10 | minutes |
| 175° | C. | 3 | minutes | 7.5 | minutes |
| 180° | C. | 2 | minutes | 5 | minutes, |

wherein the baking step does not comprise a devulcanization means.

14. The method according to claim 13, wherein a pressure used during the baking step is between 2*10⁴ Pa and atmospheric pressure.

15. The method according to claim 13, wherein the rubber granulate is in a form of particles, a volume mean diameter D50 of which is between 0.8 mm and 20 mm.

16. The method according to claim 13, wherein the rubber granulate is a rubber crumb in a form of particles, a volume mean diameter D50 of which is between 10 μm and 800 μm.

17. The method according to claim 13, further comprising a prior step of grinding a vulcanized rubber article to provide the rubber granulate.

18. The method according to claim 13, wherein the rubber granulate is heated during the baking step at a temperature of between 60° C. and 130° C.

19. The method according to claim 18, wherein the rubber granulate is heated during the baking step at a temperature of between 65° C. and 120° C.

20. The method according to claim 19, wherein the rubber granulate is heated during the baking step at a temperature of between 75° C. and 110° C.

21. The method according to claim 14, wherein the pressure used during the baking step is between 3*10⁴ Pa and 5*10⁴ Pa.

22. The method according to claim 15, wherein the rubber granulate is in the form of particles, the volume mean diameter D50 of which is between 0.8 mm and 8 mm.

23. The method according to claim 16, wherein the rubber granulate is a rubber crumb in the form of particles, the volume mean diameter D50 of which is between 50 μm and 200 μm.

24. The method according to claim 17, wherein the vulcanized rubber article is used tires or fragments of used tires.

25. A deodorized rubber granulate obtained according to the method of claim 13.

26. A method for manufacturing an article made of rubber granulate comprising the following successive steps:
providing the deodorized rubber granulate according to claim 25;
sintering the deodorized granulate in a mold; and
recovering the article obtained at the end of the sintering step.

27. The method according to claim 26, wherein the recovering step directly follows the baking step so that the granulate is introduced into the mold for shaping thereof by sintering at a temperature above 30° C.

28. The method according to claim 26, further comprising a step of grinding a vulcanized rubber article to provide the granulate comprising rubber in the vulcanized state.

29. An article made of deodorized rubber granulate obtained by the method according to claim 26.

30. A method of producing a playing field, athletics tracks, playground, shoe sole or solid castor comprising:
a step of utilizing the article according to claim 29.

31. The method according to claim 26 further comprising, between the providing step and the sintering step, preparing a composition comprising the deodorized rubber granulate and metallic, inorganic or organic particles, wherein sintering the deodorized granulate comprises sintering the composition.
